(19) United States
(12) Patent Application Publication
(10) Pub. No.: US 2020/0018459 A1
(43) Pub. Date: Jan. 16, 2020

(54) LIGHT FIXTURE COVER AND LIGHT FIXTURE COMPRISING THE SAME

(71) Applicant: CORNING INCORPORATED, CORNING, NY (US)

(72) Inventors: Paul Bennett Dohn, Corning, NY (US); Jin Su Kim, Paintes Post, NY (US)

(21) Appl. No.: 16/464,450

(22) PCT Filed: Nov. 28, 2017
(86) PCT No.: PCT/US2017/063390

§ 371 Date: May 28, 2019

Related U.S. Application Data
(60) Provisional application No. 62/426,691, filed on Nov. 28, 2016.

(51) Int. Cl. F21V 3/10; C03B 17/02; F21V 3/06

(52) U.S. Cl. CPC F21V 3/10; F21V 3/0615; C03B 17/02

(57) ABSTRACT

A strengthened glass cover for a light fixture includes a glass core layer, a first glass cladding layer fused to a first surface of the glass core layer, and a second glass cladding layer fused to a second surface of the glass core layer. A coefficient of thermal expansion (CTE) of the glass core layer is greater than a CTE of each of the first glass cladding layer and the second glass cladding layer, whereby the glass core layer is in tension and each of the first glass cladding layer and the second glass cladding layer is in compression. A light fixture includes a housing and the cover coupled to the housing.

This application claims the benefit of priority under 35 U.S.C. § 119 of U.S. Provisional Application No. 62/426,691, filed on Nov. 28, 2016, the content of which is relied upon and incorporated herein by reference in its entirety.

### BACKGROUND

### 1. Field

This disclosure relates to light fixtures and, more particularly, to strengthened glass covers for light fixtures and light fixtures comprising strengthened glass covers.

### 2. Technical Background

Light fixtures generally include a housing and a cover. The housing is mounted to a ceiling or a wall of a building and houses the electrical wiring that powers a light source coupled to the housing. The cover is mounted to the housing and positioned such that light emitted by the light source is incident on the cover. The cover can help to hide the light source from view and/or act as a diffuser to diffuse the light emitted by the light source.

In some conventional light fixtures, the cover is formed from a polymeric material. Although such polymeric materials are thin, light, and relatively easy to 3D form into various non-planar shapes, they can be susceptible to yellowing and/or becoming brittle and subject to cracking over time. Moreover, such polymeric materials generally are not capable of withstanding exposure to high temperatures that may be associated with some types of light sources (e.g., heat lamps).

In other conventional light fixtures, the cover is formed from a tempered glass material. Although such tempered glass materials resist yellowing and are strengthened to prevent breakage, they generally are relatively thick and heavy. Moreover, such tempered glass materials generally cannot be 3D formed or decorated using high temperature processes (such as frit or enamel decoration) after tempering because subjecting the cover to high temperature will result in the glass losing its strength.

Thus, there is a need for thin, light weight light fixture covers that are resistant to breakage, will not yellow over time, and are capable of withstanding high temperatures either during use or during manufacturing (e.g., 3D forming and/or decoration).

### SUMMARY

Disclosed herein are strengthened light fixture covers and light fixtures comprising such covers.

Disclosed herein is a strengthened glass cover for a light fixture, the cover comprising a glass core layer, a first glass cladding layer fused to a first surface of the glass core layer, and a second glass cladding layer fused to a second surface of the glass core layer. A coefficient of thermal expansion (CTE) of the glass core layer is greater than a CTE of each of the first glass cladding layer and the second glass cladding layer, whereby the glass core layer is in tension and each of the first glass cladding layer and the second glass cladding layer is in compression.

Disclosed herein is a light fixture comprising a housing and the cover coupled to the housing.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a perspective view of some embodiments of a light fixture.

FIG. 2 is a schematic cross-sectional view of the light fixture cover shown in FIG. 1.

FIG. 3 is a schematic cross-sectional view of some embodiments of a glass laminate structure of a light fixture cover.

FIG. 4 is a perspective view of some embodiments of a light fixture.

FIG. 5 is a schematic cross-sectional view of the light fixture cover shown in FIG. 4.

FIG. 6 is a front view of some embodiments of a light fixture cover.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

As used herein, the term “average coefficient of thermal expansion,” or “average CTE,” refers to the average coefficient of linear thermal expansion of a given material or layer between 0° C. and 300° C. As used herein, the term “coefficient of thermal expansion,” or “CTE,” refers to the average coefficient of thermal expansion unless otherwise indicated. The CTE can be determined, for example, using the procedure described in ASTM E228 “Standard Test Method for Linear Thermal Expansion of Solid Materials With a Push-Rod Dilatometer” or ISO 7991:1987 “Glass-Determination of coefficient of mean linear thermal expansion.”

In various embodiments described herein, a glass cover comprises a compressive stress or a tensile stress at a given depth within the glass cover (e.g., a distance from an outer surface of the glass cover). Compressive stress and/or tensile stress values can be determined using any suitable technique including, for example, a birefringence based measurement technique, a refracted near-field (RNF) technique, or a photoelastic measurement technique (e.g., using a polarimeter). Exemplary standards for stress measurement include, for example, ASTM C1422/C1422M-10 “Standard Specification for Chemically Strengthened Flat Glass” and ASTM F218 “Standard Method for Analyzing Stress in Glass.” The “stress profile” of a glass cover is the relationship of stress to depth within the glass cover (e.g., as represented by a plot of stress versus depth).

In various embodiments, a strengthened glass cover for a light fixture comprises a glass core layer, a first glass cladding layer fused to a first surface of the glass core layer, and a second glass cladding layer fused to a second surface of the glass core layer. A coefficient of thermal expansion (CTE) of the glass core layer is greater than a CTE of each of the first glass cladding layer and the second glass cladding layer, whereby the glass core layer is in tension and each of the first glass cladding layer and the second glass cladding layer is in compression.

A glass cover that is strengthened as a result of a CTE mismatch between adjacent glass layers as described herein can be referred to as a mechanically strengthened glass cover. Such a mechanically strengthened glass cover can have certain advantages compared to conventional polymeric covers and/or thermally tempered glass covers. For example, because it is made of glass, a mechanically strengthened glass cover can be resistant to yellowing over time as some polymeric covers tend to do. Additionally, or alternatively, a mechanically strengthened glass cover can be capable of withstanding higher temperatures than conventional polymeric covers, such as temperatures that may be associated with high temperature manufacturing processes such as 3D forming and decoration and/or high temperature uses such as use with high intensity discharge (HID) lamps, ultraviolet (UV) lamps, and/or infrared (IR) lamps. Additionally, or alternatively, a mechanically strengthened glass cover can be more resistant to solvents that may be found in cleaning products compared to polymeric covers. Additionally, or alternatively, because mechanical strengthening can be achieved with relatively thin glass layers, a mechanically strengthened glass cover can be thinner, and therefore lighter, than a conventional thermally tempered glass cover. Additionally, or alternatively, a mechanically strengthened glass cover can be subjected to a 3D forming process and/or a high temperature printing process (e.g., using glass frit or an enamel) after strengthening and without losing strength as thermally tempered glass covers tend to do.

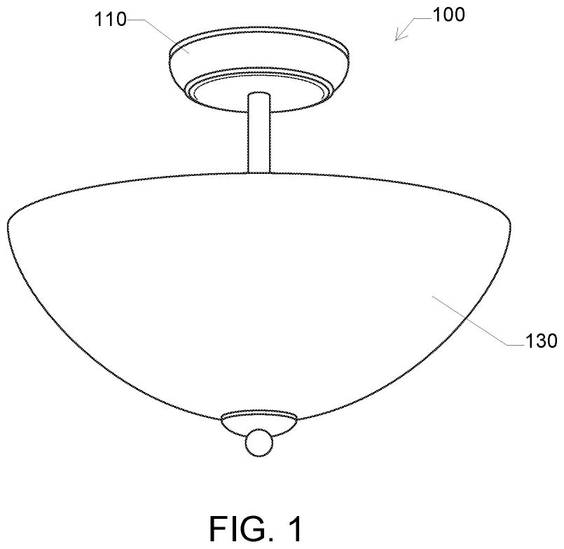

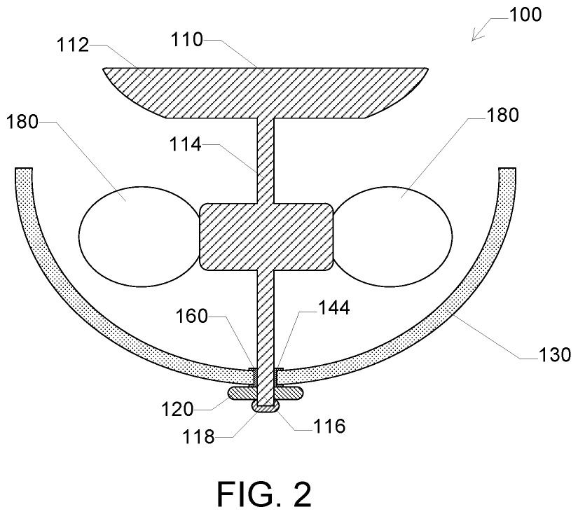

FIG. 1 is a perspective view of some embodiments of a light fixture 100, and FIG. 2 is a schematic cross-sectional view of the light fixture shown in FIG. 1. Light fixture 100 comprises a housing 110 and a cover 130 coupled to the housing. In some embodiments, cover 130 is a strengthened glass cover (e.g., a mechanically strengthened glass cover).

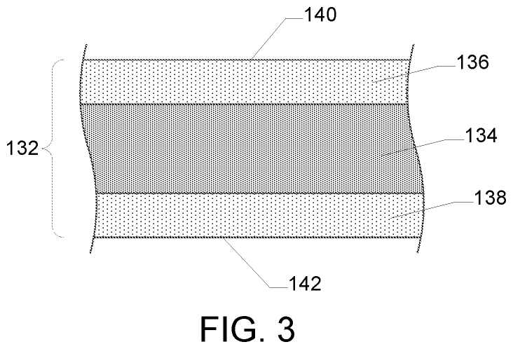

FIG. 3 is a schematic cross-sectional view of cover 130. In some embodiments, cover 130 comprises a glass laminate structure 132. For example, glass laminate structure 132 comprises a glass core layer 134, a first glass cladding layer 136 fused to a first surface of the glass core layer, and a second glass cladding layer 138 fused to a second surface of the glass core layer. Each of glass core layer 134, first glass cladding layer 136, and second glass cladding layer 138, independently, comprises or is formed from a glass material, a ceramic material, a glass-ceramic material, or a combination thereof. In some embodiments, a CTE of glass core layer 134 is greater than a CTE of each of first glass cladding layer 136 and second glass cladding layer 138, whereby the glass core layer is in tension and each of the first glass cladding layer and the second glass cladding layer is in compression.

In some embodiments, an interface between first glass cladding layer 136 and glass core layer 134 and/or an interface between second glass cladding layer 138 and glass core layer 134 are free of any bonding material such as, for example, an adhesive, a coating layer, or any non-glass material added or configured to adhere the respective cladding layers to the core layer. Thus, first glass cladding layer 136 and/or second glass cladding layer 138 are fused directly to glass core layer 134 or are directly adjacent to the glass core layer. In some embodiments, the glass laminate structure comprises a diffusion layer disposed between the glass core layer and the first glass cladding layer and/or between the glass core layer and the second glass cladding layer. For example, the diffusion layer can be a blended region comprising components of each layer adjacent to the diffusion layer (e.g., a blended region between two directly adjacent glass layers).

In some embodiments, glass core layer 134 comprises a first glass composition, and first and/or second glass cladding layers 136 and 138 comprise a second glass composition that is different than the first glass composition. For example, in the embodiments shown in FIG. 3, glass core layer 134 comprises the first glass composition, and each of first glass cladding layer 136 and second glass cladding layer 138 comprises the second glass composition. In other embodiments, the first glass cladding layer comprises the second glass composition, and the second glass cladding layer comprises a third glass composition that is different than the first glass composition and the second glass composition.

Glass laminate structure 132 can be formed using a suitable process such as, for example, a fusion draw, down draw, slot draw, up draw, or float process. In some embodiments, glass laminate structure 132 is formed using a fusion draw process as described, for example, in U.S. Pat. No. 4,214,886, which is incorporated herein by reference in its entirety. A glass laminate structure formed using such a fusion draw process can be referred to as a fusion drawn glass laminate structure. In some embodiments of a fusion draw process, the first glass composition is melted and fed to a lower overflow distributor or isopipe, and the second glass composition is melted and fed to an upper overflow distributor or isopipe positioned above the lower overflow distributor. The first glass composition overflows opposing sides of the lower overflow distributor and flows down opposing outer forming surfaces of the lower the overflow distributor. The separate streams of the first glass composition flowing down the opposing outer forming surfaces of the lower overflow distributor converge at a draw line where they are fused together to form glass core layer 134 of glass laminate structure 132. The second glass composition overflows opposing sides of the upper overflow distributor and flows down opposing outer forming surfaces of the upper overflow distributor. The separate streams of the second glass composition contact and are fused to the separate streams of the first glass composition flowing down the outer forming surfaces of the lower overflow distributor. Upon convergence of the streams of the first glass composition at the draw line, the second glass composition forms first glass cladding layer 136 and second glass cladding layer 138 of glass laminate structure 132.

In some embodiments, the first glass composition of glass core layer 134 in the viscous state (e.g., above its softening temperature) is contacted with the second glass composition of first and second glass cladding layers 136 and 138 in the viscous state (e.g., above its softening temperature) to form glass laminate structure 132 as described herein. Upon cooling from the viscous state, glass core layer 134 contracts at a greater rate than each of first glass cladding layer 136 and second glass cladding layer 138 as a result of the CTE mismatch between the glass core layer and the first and second glass cladding layers. Such differential rates of contraction cause compressive stresses to form in each of first glass cladding layer 136 and second glass cladding layer 138 and tensile stress to form in glass core layer 134, thereby strengthening glass laminate structure 132.

In some embodiments, first glass cladding layer 136 and second glass cladding layer 138 are formed from a glass composition (e.g., the second glass composition) having a lower CTE than a glass composition (e.g., the first glass composition) of glass core layer 134. The CTE mismatch (e.g., the difference between the CTE of first and second glass cladding layers 136 and 138 and the CTE of glass core layer 134) results in formation of compressive stress in the glass cladding layers and tensile stress in the glass core layer upon cooling of glass laminate structure 132. Surface compressive stresses tend to suppress existing surface flaws from developing into cracks. In some embodiments, the CTE of glass core layer 134 and the CTE of first glass cladding layer 136 and/or second glass cladding layer 138 differ by about 5×10⁷° C.⁻¹ or more, about 10×10⁷° C.¹ or more, about 15×10⁷° C.¹ or more, about 20×10⁷° C.¹ or more, about 25×10⁷° C.¹ or more, or about 30×10⁷° C.¹ or more. Additionally, or alternatively, the CTE of glass core layer 134 and the CTE of first glass cladding layer 136 and/or second glass cladding layer 138 differ by about 100×10⁷° C.¹ or less, about 75×10⁷° C.¹ or less, about 50×10⁷° C.¹ or less, about 40×10⁷° C.¹ or less, about 30×10⁷° C.¹ or less, about 20×10⁷° C.¹ or less, or about 10×10⁷° C.¹ or less. In some embodiments, first glass cladding layer 136 and/or second glass cladding layer 138 comprise a CTE of about 66×10⁷° C.¹ or less, about 55×10⁷° C.¹ or less, about 50×10⁷° C.¹ or less, about 40×10⁷° C.¹ or less, or about 35×10⁷° C.¹ or less. Additionally, or alternatively, first glass cladding layer 136 and/or second glass cladding layer 138 comprise a CTE of about 10×10⁷° C.¹ or more, about 15×10⁷° C.¹ or more, about 25×10⁷° C.¹ or more, or about 30×10⁷° C.¹ or more. Additionally, or alternatively, glass core layer 134 comprises a CTE of about 40×10⁻⁷° C.⁻¹ or more, about 50×10⁻⁷° C.⁻¹ or more, about 55×10⁻⁷° C.⁻¹ or more, about 65×10⁷° C.¹ or more, about 70×10⁷° C.¹ or more, about 80×10⁷° C.¹ or more, or about 90×10⁷° C.¹ or more. Additionally, or alternatively, glass core layer 134 comprises a CTE of about 120×10⁷° C.¹ or less, about 110×10⁷° C.¹ or less, about 100×10⁷° C.¹ or less, about 90×10⁷° C.¹ or less, about 75×10⁷° C.¹ or less, or about 70×10⁷° C.¹ or less.

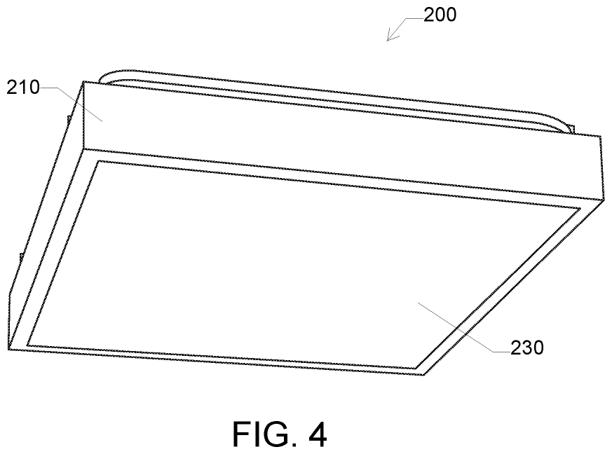

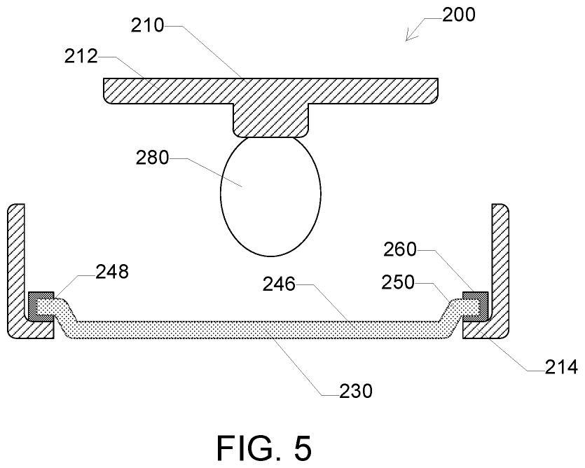

In some embodiments, glass laminate structure 132 is formed as a glass laminate sheet. For example, the glass laminate sheet is planar or substantially planar. In some embodiments, the glass laminate sheet is used as the glass cover. In other embodiments, the glass laminate sheet is subjected to a 3D forming process to form a glass cover having a determined non-planar shape. For example, in some embodiments, cover 130 comprises a bowl shape as shown in FIGS. 1-2. In other embodiments, cover 130 comprises a central region, a rim, and a bend disposed between the central region and the bend as shown in FIGS. 4-5. In other embodiments, the cover comprises another suitable non-planar shape. A 3D forming process can comprise a molding process, a pressing process, a sagging process, or another suitable forming process. In some embodiments, the 3D forming process comprises heating glass laminate structure 132 to a high temperature (e.g., above a strain point, an annealing point, and/or a softening point of one or more glass layers). Because the strengthening of glass laminate structure 132 is a result of the CTE mismatch between glass core layer 134 and each of first glass cladding layer 136 and second glass cladding layer 138, the compressive and tensile stresses are regenerated upon cooling the glass laminate structure after 3D forming. Thus, the strengthening of glass laminate structure 132 is not substantially affected by the 3D forming process.

Although glass laminate structure 132 shown in FIG. 3 comprises three layers, other embodiments are included in this disclosure. In other embodiments, a glass laminate structure can have a determined number of layers, such as four, five, or more layers.

A thickness of glass laminate structure 132, and thus a thickness of cover 130, is a distance between opposing outer surfaces of the glass laminate structure (e.g., the distance between an outer surface 140 of first glass cladding layer 136 and an outer surface 142 of second glass cladding layer 138). In some embodiments, the thickness of glass laminate structure 132 is about 0.05 mm or more, about 0.1 mm or more, about 0.2 mm or more, or about 0.3 mm or more. Additionally, or alternatively, the thickness of glass laminate structure 132 is about 2 mm or less, about 1.5 mm or less, about 1 mm or less, about 0.7 mm or less, or about 0.5 mm or less. In some embodiments, a ratio of a thickness of glass core layer 134 to a thickness of glass laminate structure 132 is about 0.7 or more, about 0.8 or more, about 0.85 or more, about 0.9 or more, or about 0.95 or more. Additionally, or alternatively, the ratio of the thickness of glass core layer 134 to the thickness of glass laminate structure 132 is about 0.95 or less, about 0.93 or less, about 0.9 or less, about 0.87 or less, or about 0.85 or less. In some embodiments, first glass cladding layer 136 and/or second glass cladding layer 138, independently, comprise a thickness of about 0.01 mm to about 0.3 mm.

In some embodiments, cover 130 comprises one or more openings formed therein. For example, in the embodiments shown in FIGS. 1-2, cover 130 comprises an opening 144 formed at an apex of the bowl shape. Housing 110 can engage cover 130 at opening 144 to couple the cover to the housing as described herein.

In some embodiments, cover 130 is coupled to housing 110. In some of such embodiments, housing 110 comprises a base portion 112 and a mounting element 114 extending from the base portion. Base portion 112 can be secured to a ceiling, a wall, or another surface to fasten light fixture 100 to a building, a piece of furniture, or another object to which the light fixture is to be fastened. Mounting element 114 can engage cover 130 to couple the cover to housing 110. For example, in the embodiments shown in FIGS. 1-2, mounting element 114 comprises an elongate rod extending from base portion 112. In some embodiments, mounting element 114 is received within opening 144 in cover 130. For example, the elongate rod extends through opening 144 as shown in FIGS. 1-2. In some embodiments, mounting element 114 comprises exterior threads at a distal end 116 of the mounting element. In some of such embodiments, housing 110 comprises a fastener 118 that is engageable with mounting element 114. For example, in some embodiments, fastener 118 is a nut comprising internal threads engageable with the external threads at distal end 116 of mounting element 114. Fastener 118 can be secured to mounting element 114 to retain cover 130 in engagement with the mounting element. In some embodiments, housing 110 comprises a washer 120 disposed between fastener 118 and cover 130. Washer 120 can help to hide opening 144 from view. Additionally, or alternatively, washer 120 can be formed from a cushioning material such as rubber or silicone to protect cover 130 from contact with fastener 118.

In some embodiments, opening 144 is a hole or aperture extending entirely through laminate structure 132 of cover 130. Thus, a perimeter of opening 144 is defined by an interior edge of cover 130. In some embodiments, an exposed portion of glass core layer 134 is exposed at the interior edge. For example, a hole is drilled through glass laminate structure 132 to form opening 144 in cover 130, thereby exposing a portion of glass core layer 134 at an edge of the opening. Glass core layer 134 can be in tension as described herein. Because glass in tension is particularly susceptible to crack propagation and failure, it may be beneficial to protect the exposed portion of glass core layer 134 from contact with housing 110.

In some embodiments, light fixture 100 comprises a gasket 160 disposed between cover 130 and housing 110. For example, in the embodiments shown in FIGS. 1-2, gasket 160 is disposed within opening 144 between cover 130 and mounting element 114. Thus, gasket 160 is disposed between the exposed portion of glass core layer 134 and mounting element 114, which can help to prevent contact between housing 110 and the exposed portion of the glass core layer. In some embodiments, gasket 160 comprises a cushioning material that can help to protect cover 130 from contact with housing 110. Additionally, or alternatively, the interior edge of cover 130 is received within a channel formed in an outer surface of gasket 160, which can help to retain the gasket in place within opening 144 and/or further protect the interior edge.

In some embodiments, light fixture 100 comprises one or more light sources 180. For example, light sources 180 are coupled to housing 110 and positioned to emit light toward cover 130. In some embodiments, light sources 180 are light bulbs (e.g., light emitting diode (LED) bulbs, compact fluorescent (CFL) bulbs, halogen bulbs, incandescent bulbs, or another type of light bulb). For example, light sources 180 emit light in a visible spectrum (e.g., wavelengths of about 390 nm to about 700 nm), which can be useful for architectural lighting applications. Additionally, or alternatively, light sources 180 emit light in an UV spectrum (e.g., wavelengths of about 10 nm to about 400 nm) and/or an IR spectrum (e.g., wavelengths of about 700 nm to about 1000000 nm). For example, in some embodiments, light sources 180 are heat lamps (e.g., used in bathroom or food service applications).

FIG. 4 is a perspective view of some embodiments of a light fixture 200, and FIG. 5 is a schematic cross-sectional view of the light fixture shown in FIG. 4. Light fixture 200 comprises a housing 210 and a cover 230 coupled to the housing. In some embodiments, cover 230 is a strengthened glass cover. For example, cover 230 comprises glass laminate structure 132 described herein in reference to FIG. 3.

In some embodiments, cover 230 comprises a central region 246 and a rim 248 at least partially circumscribing the central region. For example, rim 248 entirely circumscribes central region 246. Rim 248 is offset from central region 246. For example, in the embodiments shown in FIGS. 4-5, each of central region 246 and rim 248 is substantially planar, and the plane of the central region does not intersect with the plane of the rim (e.g., the planes are substantially parallel). In other embodiments, the central region and the rim, independently, can be planar or non-planar and can have the same or different shapes or contours. In some embodiments, cover 230 comprises at least one bend 250 disposed between central region 246 and rim 248. For example, in the embodiments shown in FIGS. 4-5, cover 230 comprises two bends separated coupled by a substantially linear segment positioned therebetween. Bend 250 comprises a contoured portion of cover 230 that can serve as a transition between central region 246 and rim 248. In some embodiments, bend 250 comprises a radius of 10 mm or less, 8 mm or less, 6 mm or less, 5 mm or less, 4 mm or less, or 3 mm or less. Such a small radius can be enabled, for example, by the small thickness of laminate structure 132.

In some embodiments, cover 230 is coupled to housing 210. In some of such embodiments, housing 210 comprises a base portion 212 and a mounting element 214 extending from the base portion. Base portion 212 can be secured to a ceiling, a wall, or another surface to fasten light fixture 200 to a building, a piece of furniture, or another object to which the light fixture is to be fastened. Mounting element 214 can be coupled to base portion 212, for example, by one or more arms extending outward from the base portion. Thus, base portion 212 can be hidden from view by mounting element 214 and/or cover 230. Mounting element 214 can engage cover 230 to couple the cover to housing 210. For example, in the embodiments shown in FIGS. 4-5, mounting element 214 comprises an engaging lip. In some embodiments, mounting element 214 engages rim 248 of cover 230. For example, the engaging lip at least partially circumscribes an interior space of housing 110 and extends inward toward the interior space. Thus, the engaging lip defines a frame partially or entirely circumscribing the interior space. In some of such embodiments, central region 246 of cover is received within the interior space of housing 210 such that rim 248 rests on the engaging lip to couple the cover to the housing.

In some embodiments, an exterior edge is defined by a perimeter of cover 230 (e.g., a perimeter of rim 248). In some of such embodiments, an exposed portion of glass core layer 134 is exposed at the exterior edge. For example, glass laminate structure 132 is cut during manufacturing to form the perimeter of cover 230, thereby exposing a portion of glass core layer 134 at the exterior edge. Glass core layer 134 can be in tension as described herein. Because glass in tension is particularly susceptible to crack propagation and failure, it may be beneficial to protect the exposed portion of glass core layer 134 from contact with housing 210.

In some embodiments, the exposed portion of glass core layer 134 is spaced from housing 210. For example, the engaging lip is wider than rim 248 of cover 230 such that the edge of the cover is spaced from a side wall of housing 210. Such spacing can help to reduce the potential for contact between the exposed portion of glass core layer 134 and housing 210. In some embodiments, light fixture 200 comprises a gasket 260 disposed between cover 230 and housing 210. For example, in the embodiments shown in FIGS. 4-5, gasket 260 is disposed between the edge of rim 248 and housing 210. Thus, gasket 260 is disposed between the exposed portion of glass core layer 134 and housing 210, which can help to prevent contact between the housing and the exposed portion of the glass core layer. In some embodiments, gasket 260 comprises a cushioning material that can help to protect cover 230 from contact with housing 210. Additionally, or alternatively, the exterior edge of cover 230 is received within a channel formed in an inner surface of gasket 260, which can help to retain the gasket in place on the engaging lip of housing 210 and/or further protect the exterior edge.

In some embodiments, light fixture 200 comprises one or more light sources 280, which can be configured as described herein in reference to light sources 180. For example, light source 280 is coupled to housing 210 and positioned to emit light toward cover 230.

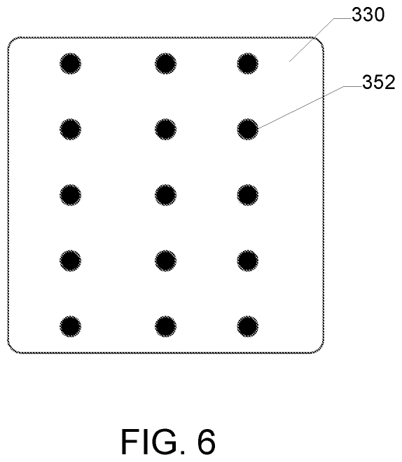

FIG. 6 is a front view of some embodiments of a cover 330 for a light fixture. Cover 330 comprises a glass laminate structure 132 as described herein in reference to cover 130 and cover 230. In some embodiments, cover 330 comprises a printed pattern 352 disposed on at least one of first glass cladding layer 136 or second glass cladding layer 138. For example, printed pattern 352 is applied to the outer surface of glass laminate structure 132 using a suitable printing process. In the embodiments shown in FIG. 6, printed pattern 352 comprises an array of dots disposed on the outer surface of glass laminate structure 132. In other embodiments, the printed pattern comprises any type of decorative or functional pattern applied to the outer surface of the laminate structure. In some embodiments, printed pattern 352 comprises a glass frit applied to glass laminate structure 132. In other embodiments, printed pattern 352 comprises an enamel applied to glass laminate structure 132. In some of such embodiments, the enamel is fired.

In some embodiments, printed pattern 352 serves a decorative or aesthetic purpose. For example, printed pattern 352 can comprise a variety of different colors and/or designs intended to impart a particular style to cover 330. In some embodiments, printed pattern 352 imparts a determined optical characteristic to cover 330. For example, in some embodiments, cover 330 transmits a determined amount of light incident thereon (e.g., from light source 180), reflects a determined amount of light incident thereon, and absorbs a determined amount of light incident thereon. The determined amounts of light that are transmitted, reflected, and/or absorbed can be controlled, at least in part, by printed pattern 352. For example, cover 330 transmits about 50% or more, about 60% or more, about 70% or more, about 80% or more, or about 90% or more of the light emitted by light source 180 and incident thereon. Additionally, or alternatively, cover 330 transmits about 100% or less, about 99% or less, about 90% or less, about 80% or less, or about 60% or less of the light emitted by light source 180 and incident thereon. Additionally, or alternatively, cover 330 reflects about 10% or more, about 20% or more, about 30% or more, about 40% or more, or about 50% or more of the light emitted by light source 180 and incident thereon. Additionally, or alternatively, cover 330 reflects about 60% or less, about 50% or less, about 40% or less, about 30% or less, or about 20% or less of the light emitted by light source 180 and incident thereon. In some embodiments, cover 330 is substantially transparent prior to depositing printed pattern 352 thereon, and the printed pattern controls the transmission and/or reflection of light incident on the cover. Controlling the amount of light transmitted and reflected by cover 330 can help to control the amount of light directed directly into a room through the cover compared to the amount of light directed indirectly into the room via a wall or a ceiling (e.g., light reflected by the cover toward the wall or ceiling before being redirected into the room), which can enable a desired ambiance within the room. Printed pattern 352 can be transparent, translucent, or opaque. For example, a translucent printed pattern 352 can serve as a light diffuser.

In some embodiments, glass laminate structure 132 comprises a plurality of scattering centers. For example, one or more layers of glass laminate structure 132 is at least partially crystallized and/or phase separated. The crystals or different phases can serve as scattering centers. In such embodiments, glass laminate structure 132 can serve as a light diffuser.

It will be apparent to those skilled in the art that various modifications and variations can be made without departing from the spirit or scope of the claimed subject matter. Accordingly, the claimed subject matter is not to be restricted except in light of the attached claims and their equivalents.

1. A strengthened glass cover for a light fixture, the cover comprising:
a glass core layer;
a first glass cladding layer fused to a first surface of the glass core layer; and
a second glass cladding layer fused to a second surface of the glass core layer;
wherein a coefficient of thermal expansion (CTE) of the glass core layer is greater than a CTE of each of the first glass cladding layer and the second glass cladding layer, whereby the glass core layer is in tension and each of the first glass cladding layer and the second glass cladding layer is in compression.

2. The cover of claim 1, comprising an opening in a central region of the cover for receiving a mounting element of the light fixture.

3. The cover of claim 1, comprising a non-planar shape.

4. The cover of claim 3, wherein the non-planar shape is a bowl shape.

5. The cover of claim 3, wherein the non-planar shape comprises a central region and a rim at least partially circumscribing the central region for engaging a housing of the light fixture.

6. The cover of claim 5, wherein the non-planar shape comprises a bend disposed between the central region and the rim.

7. The cover of claim 6, wherein a radius of the bend is about 10 mm or less.

8. The cover of claim 1, comprising a printed pattern disposed on at least one of the first glass cladding layer or the second glass cladding layer.

9. The cover of claim 8, wherein the printed pattern comprises a glass frit.

10. The cover of claim 8, wherein the printed pattern comprises an enamel.

11. The cover of claim 10, wherein the enamel is fired.

12. The cover of any of claim 1, wherein a thickness of the cover is about 2 mm or less.

13. A light fixture comprising:
a housing; and
the cover of any of claim 1 coupled to the housing.

14. The light fixture of claim 13, wherein:
the housing comprises an engaging lip; and
the cover comprises a rim engaged by the engaging lip of the housing to couple the cover to the housing.

15. The light fixture of claim 14, wherein:
an exposed portion of the core layer is exposed at an edge of the rim; and
the exposed portion of the core layer is spaced from the housing.

16. The light fixture of claim 14, comprising a gasket disposed between an edge of the rim and the housing and adjacent the engaging lip of the housing.

17. The light fixture of claim 13, wherein:
the housing comprises a mounting element extending therefrom;
the cover comprises an opening; and
the mounting element of the housing is received within the opening of the cover.

18. The light fixture of claim 17, wherein an exposed portion of the core layer is exposed at an edge of the opening.

19. The light fixture of claim 17, comprising a gasket disposed between the cover and the housing and within the opening of the cover.

20. The light fixture of claim 17, wherein:
the mounting element comprises an elongate rod with a threaded end received within the opening; and
the light fixture comprises a nut threaded onto the threaded end of the mounting element to couple the cover to the housing.

21. The light fixture of claim 13, comprising a light source that emits light toward the cover.

22. The light fixture of claim 21, wherein the cover transmits at least 50% of the light emitted by the light source and incident on the cover and reflects at least about 10% of the light emitted by the light source and incident on the cover.

23. The light fixture of claim 21, wherein the light source is a heat lamp that emits infrared (IR) light.
